(19) United States
(12) Patent Application Publication
(10) Pub. No.: US 2005/0260552 A1
(43) Pub. Date: Nov. 24, 2005

(54) Apparatus and method for educational game hoop

(76) Inventor: Larry L. Anderson, Taylors, SC (US)

Correspondence Address: CRAVEN & REID, LLC, 12 E. STONE AVENUE, GREENVILLE, SC, 29609, US

(21) Appl. No.: 10/832,508

(22) Filed: Apr. 27, 2004

(51) Int. Cl. G09B 7/00

(52) U.S. Cl. 434/322

(57) ABSTRACT

Apparatus and method for an educational game hoop that may be rolled or spun on the ground by a player or rotated about the body, waist, neck, or arms of a player. The educational game hoop has a plurality of questions and corresponding answers on the hoop surface. The plurality of questions are preferably on at least one hoop surface and the plurality of corresponding answers are preferably on at least one other hoop surface.

### BACKGROUND

The present invention is related to educational game toys, and in particular to educational game toy hoops that are rotated about the body, waist, neck, or arms.

Hoop toys that are rolled or spun about the body, waist, neck, or arms are well known in the art. U.S. Pat. No. 3,079,728 represents the archetype of a hoop toy that may be spun about the body. Variations of this archetype have emerged since, such as: musical hoop toys, lighted hoop toys, segmented hoop toys, decorative cloth covered hoop toys, water filled hoop toys, and water emitting hoop toys.

### SUMMARY

The present invention comprises an educational game hoop apparatus having a closed hoop having continuous upper and lower, and inner and outer surfaces; a plurality of questions on at least one hoop surface; and a plurality of corresponding answers on at least one other hoop surface.

The present invention further comprises method of manufacturing an educational game hoop apparatus comprising the steps of providing a closed hoop having continuous upper and lower, and inner and outer surfaces; providing a plurality of questions on at least one hoop surface; and providing a plurality of corresponding answers on at least one other hoop surface.

The present invention further comprises a method of operating an educational game hoop apparatus comprising the steps of providing a closed hoop having continuous upper and lower, and inner and outer surfaces; providing a plurality of questions on at least one hoop surface; providing a plurality of corresponding answers on at least one other hoop surface; causing rotation of the hoop; causing a discontinuance of the hoop rotation; determining a question provided on the hoop surface to be answered; and verifying the question's corresponding answer provided on the hoop surface.

### BRIEF DESCRIPTION OF THE DRAWINGS

FIG. 1 is a perspective view illustrating the rotation around the body of an educational game hoop constructed in accordance with the invention;

FIG. 2a is an elevational view illustrating a question provided on a surface of an educational game hoop constructed in accordance with the present invention;

FIG. 2b is an elevational view illustrating a corresponding answer to the question of FIG. 2a, provided on another surface of an educational game hoop constructed in accordance with the invention; and

FIG. 3 is a top elevational view illustrating an educational game hoop constructed in accordance with the invention.

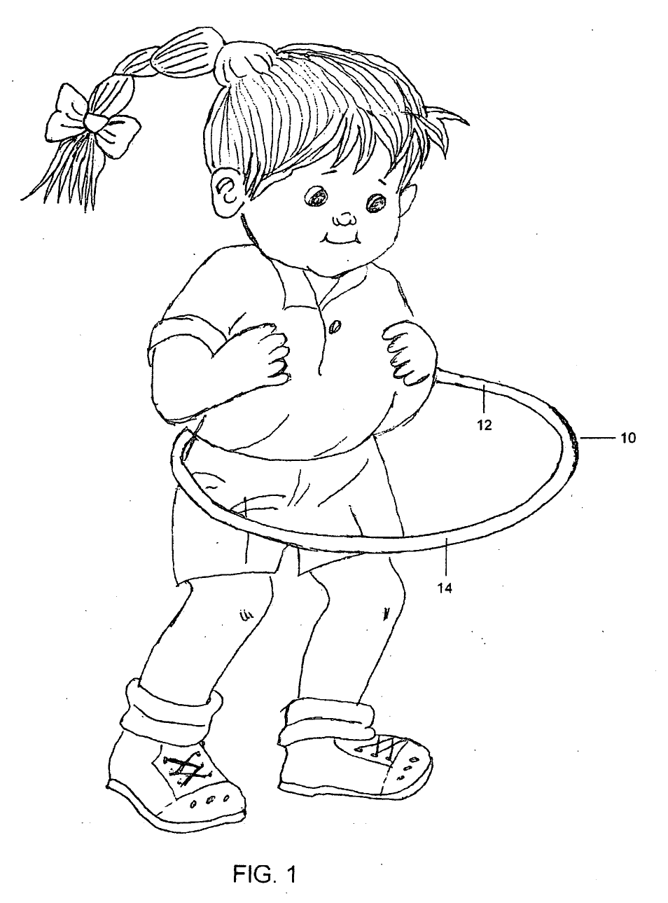

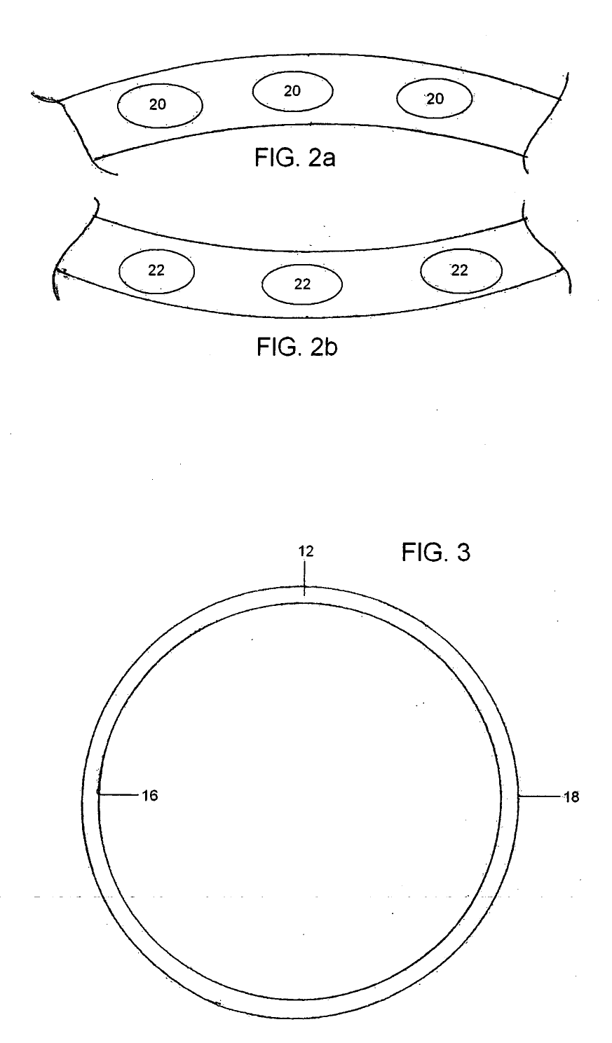

### DETAILED DESCRIPTION

The drawings illustrate an educational game hoop 10 having a continuous upper surface 12, lower surface 14, inner surface 16, and outer surface 18. The educational game hoop 10 may be rotated about the body, waist, neck, or arms of a player or rolled or spun on the ground by a player. The educational game hoop 10 has a plurality of questions 20 and corresponding answers 22 on the hoop surface. The plurality of questions 20 are preferably on at least one hoop surface and the plurality of corresponding answers 22 are preferably on at least one other hoop surface.

The educational game hoop 10 is preferably constructed from elastically flexible plastic materials such as extruded polyethylene (PE), polyethylene terephthalate (PET, PETE), polyethylene terephthalate glycol (PETG), polyvinyl chloride (PVC), high density polyethylene (HDPE), polypropylene (PP), polystyrene (PS), or other thermoplastic polyesters. Additional construction materials known in the art such as aluminum or wood may also be used.

In a preferred embodiment the plurality of questions 20 and corresponding answers 22 may be applied to the surface of the educational game hoop 10 by painting, printing, or adhering stickers to the hoop surface. In an alternative embodiment the questions and answers may be painted, printed, stitched, knitted or woven onto a fabric sleeve, which is placed over and secured to the hoop.

In yet another embodiment the questions and corresponding answers may be removably secured to the surface of the educational game hoop 10 via hook and loop fastener elements, such as VELCRO® brand hook and loop fasteners. In this embodiment one fastener element is applied to the hoop surface (hook or loop fastener element) and the corresponding fastener element is removably applied to, or comprises, the pluralities of questions 20 and pluralities of corresponding answers 22 (loop or hook fastener elements, respectively.) Through this embodiment the end user is not forced to purchase multiple hoops, each finite in the subject matter and level of difficulty conveyed. Instead, the end user needs only to buy one educational game hoop that is interchangeable and fully customizable with removable questions and corresponding answers. The removable pluralities of questions and corresponding answers may be sold separately from the hoop allowing the end user to fully customize their hoop with a variety of questions and corresponding answers with no limit of subject matter or level of difficulty inherently built into the hoop.

In a preferred game method, the educational game hoop 10 is placed about the body, waist, arm, or neck of a player. The player then causes the educational game hoop 10 to rotate about the player's body, waist, arm, or neck. The player then causes the rotation of the educational game hoop 10 to discontinue, preferably by grabbing the hoop with the player's hand. The player's hand position on the hoop would determine the question 20 provided on the hoop surface to be answered by the player, which normally will be the question nearest the player's hand. The player's answer to the question would then be verified against the corresponding answer 22 provided on another surface of the hoop. Points may be scored by answering the questions correctly and may be tallied to determine a “winner.” Alternatively, the hoop can be reversed, wherein the player is first presented with the answer and must correctly translate or respond with the corresponding question.

In yet another game method, the educational game hoop 10 rotates across the ground on its outer surface. This action is preferably achieved by the player spinning or rolling the hoop forward with a backward “snap” of the wrist to backspin the hoop back to the player. The player then causes the rotation of the hoop to discontinue, preferably by grabbing the hoop with the player's hand. The player's hand position on the hoop would determine the question 20 provided on the hoop surface to be answered by the player, which normally will be the question nearest the player's hand. The player's answer to the question would then be verified against the corresponding answer 22 provided on another surface of the hoop. Points may be scored by answering the questions correctly and may be tallied to determine a “winner.” Alternatively, the hoop can be reversed wherein the player is first presented with the answer and must correctly translate or respond with the corresponding question.

The pluralities of questions 20 and pluralities of corresponding answers 22 to be provided on the educational hoop surface may comprise a variety of subject matter and differing levels of difficulty, such that children of all education levels and ability may have specific educational game hoops or removable questions and corresponding answers targeted to their skill and ability level across a range of subjects. While the following subjects are not exhaustive, they are intended to be indicative of the subject matter contemplated for the pluralities of questions 20 and corresponding answers 22 to be provided on the hoop surface: Mathematics, English, Spelling, History, Science, Language, Foreign Language, Geography, Art, Music, Trivia, Color Recognition, Shape Recognition, Sports Recognition, Sports Trivia, Synonyms, and other educational subject matter.

While a preferred embodiment of the invention has been described using specific terms, such description is for illustrative purposes only, and it is to be understood that changes and variations may be made to the educational game hoop constructed in accordance with the invention that has a plurality of questions and corresponding answers on the hoop surface, wherein the plurality of questions are preferably on at least one hoop surface and the plurality of corresponding answers are preferably on at least one other hoop surface, without departing from the spirit or scope of the following claims.

1. An apparatus comprising:
a closed hoop having continuous upper and lower, and inner and outer surfaces;
a plurality of questions on at least one hoop surface; and
a plurality of corresponding answers on at least one other hoop surface.

2. The apparatus of claim 1, wherein the pluralities of questions are painted to the hoop surface.

3. The apparatus of claim 1, wherein the pluralities of questions are printed to the hoop surface.

4. The apparatus of claim 1, wherein the pluralities of questions are adhered to the hoop surface.

5. The apparatus of claim 1, wherein the pluralities of questions comprise a fabric sleeve, which is secured to the hoop.

6. The apparatus of claim 1, wherein the pluralities of corresponding answers are painted to the hoop surface.

7. The apparatus of claim 1, wherein the pluralities of corresponding answers are printed to the hoop surface.

8. The apparatus of claim 1, wherein the pluralities of corresponding answers are adhered to the hoop surface.

9. The apparatus of claim 1, wherein the pluralities of corresponding answers comprise a fabric sleeve, which is secured to the hoop surface.

10. The apparatus of claim 1, wherein at least one hoop surface comprises hook and loop fastener elements for removably securing corresponding hook and loop fastener elements.

11. The apparatus of claim 10, wherein the pluralities of questions comprise corresponding hook and loop fastener elements, wherein the pluralities of questions may be removably secured to the hoop surface.

12. The apparatus of claim 10, wherein the pluralities of corresponding answers comprise corresponding hook and loop fastener elements, wherein the pluralities of questions may be removably secured to the hoop surface.

13. The apparatus of claim 1, wherein the pluralities of questions and corresponding answers are selected from the group consisting of: Mathematics, English, Spelling, History, Science, Language, Foreign Language, Geography, Art, Music, Trivia, Color Recognition, Shape Recognition, Sports Recognition, Sports Trivia, Synonyms, or other educational subject matter.

14. A method comprising the steps of:
providing a closed hoop having continuous upper and lower, and inner and outer surfaces;
providing a plurality of questions on at least one hoop surface; and
providing a plurality of corresponding answers on at least one other hoop surface.

15. The method of claim 14, further comprising the step of painting the pluralities of questions to the hoop surface.

16. The method of claim 14, further comprising the step of printing the pluralities of questions to the hoop surface.

17. The method of claim 14, further comprising the step of adhering the pluralities of questions to the hoop surface.

18. The method of claim 14, further comprising the step of providing the pluralities of question on a fabric sleeve, which is secured to the hoop surface.

19. The method of claim 14, further comprising the step of painting the pluralities of corresponding answers to the hoop surface.

20. The method of claim 14, further comprising the step of printing the pluralities of corresponding answers to the hoop surface.

21. The method of claim 14, further comprising the step of adhering the pluralities of corresponding answers to the hoop surface.

22. The method of claim 14, further comprising the step of providing the pluralities of corresponding answers on a fabric sleeve, which is secured to the hoop surface.

23. The method of claim 14, further comprising the step of providing at least one hoop surface comprising hook and loop fastener elements for removably securing corresponding hook and loop fastener elements.

24. The method of claim 23, further comprising the step of providing pluralities of questions comprising corresponding hook and loop fastener elements, wherein the pluralities of questions may be removably secured to the hoop surface.

25. The method of claim 23, further comprising the step of providing pluralities of corresponding answers comprising corresponding hook and loop fastener elements, wherein the pluralities of questions may be removably secured to the hoop surface.

26. The method of claim 14, wherein the pluralities of questions and corresponding answers are selected from the group consisting of: Mathematics, English, Spelling, History, Science, Language, Foreign Language, Geography, Art, Music, Trivia, Color Recognition, Shape Recognition, Sports Recognition, Sports Trivia, Synonyms, or other educational subject matter.

27. A method comprising:
providing a closed hoop having continuous upper and lower, and inner and outer surfaces;
providing a plurality of questions on at least one hoop surface;
providing a plurality of corresponding answers on at least one other hoop surface;
causing rotation of the hoop;
causing a discontinuance of the hoop rotation;
determining a question provided on the hoop surface to be answered; and
verifying the question's corresponding answer provided on the hoop surface.

28. The method of claim 27, further comprising the step of placing the hoop about the body, waist, arm, or neck of a player.

29. The method of claim 28, further comprising the step of causing the hoop to rotate about the player's body, waist, arm, or neck.

30. The method of claim 28, further comprising the step of grabbing the hoop with the player's hand, causing the rotation of the hoop to discontinue.

31. The method of claim 28, wherein the question to be answered is determined by the question nearest the player's hand.

32. The method of claim 28, further comprising the step of scoring points by answering the questions correctly.

33. The method of claim 32, wherein the points may be tallied to determine a “winner.”

34. The method of claim 28, further comprising the step of reversing the hoop, wherein the player is first presented with the answer and must correctly translate or respond with the corresponding question.

35. The method of claim 27, further comprising the step of causing the hoop to rotate across the ground on its outer surface.

36. The method of claim 35, further comprising the step of spinning or rolling the hoop forward with a backward “snap” of the wrist to backspin the hoop back to the player.

37. The method of claim 35, further comprising the step of grabbing the hoop with the player's hand, causing the rotation of the hoop to discontinue.

38. The method of claim 35, wherein the question to be answered is determined by the question nearest the player's hand.

39. The method of claim 35, further comprising the step of scoring points by answering the questions correctly.

40. The method of claim 39, wherein the points may be tallied to determine a “winner.”

41. The method of claim 35, further comprising the step of reversing the hoop, wherein the player is first presented with the answer and must correctly translate or respond with the corresponding question.
